(19) United States
(12) Patent Application Publication
(10) Pub. No.: US 2022/0301430 A1
(43) Pub. Date: Sep. 22, 2022

(54) VEHICLE DISPATCHING METHOD, ON-VEHICLE DEVICE, AND ROADSIDE DEVICE

(71) Applicant: Panasonic Intellectual Property Management Co., Ltd., Osaka (JP)

(72) Inventors: Hiroaki SUDO, Kanagawa (JP); Tsuyoshi UENO, Kanagawa (JP); Shintaro MURAMATSU, Kanagawa (JP); Yoichi NAKAGAWA, Tokyo (JP)

(21) Appl. No.: 17/633,169

(22) PCT Filed: Jul. 21, 2020
(86) PCT No.: PCT/JP2020/028269

§ 371 Date: Feb. 4, 2022

(30) Foreign Application Priority Data
Aug. 7, 2019 (JP) 2019-145698

(51) Int. Cl. G08G 1/0968; H04N 7/18; G06V 20/52; G06V 40/10; G01C 21/34; B60W 60/00; G01C 21/36; G06Q 10/06

(52) U.S. Cl. CPC G08G 1/096811; H04N 7/183; G06V 20/52; G06V 40/10; G01C 21/3438; B60W 60/00253; G01C 21/3647; G06Q 10/06311; B60W 2556/45; B60W 2556/40

(57) ABSTRACT

Provided is a vehicle dispatching system that reduces burden on users. A roadside apparatus 4 detects a vehicle waiting person based on images captured by a camera 13, acquires the person's position data; sets a pickup point based on the person's position data and map data, acquires the pickup point's position data, and transmit it to a server 5. The server selects a vehicle to be dispatched for the person according to a positional relationship between the vehicle and the pickup point, and transmits the pickup point's position data to an in-vehicle terminal 2. The in-vehicle device or the roadside apparatus performs control so that the vehicle moves to the pickup point, when determining, based on the pickup point's position data and the map data, that a lane closest to the pickup point is for the same traveling direction as a lane in which the vehicle is traveling.

### TECHNICAL FIELD

The present disclosure relates to a vehicle dispatching method, an in-vehicle device, and a roadside device for dispatching a vehicle used as a taxi to a vehicle waiting person who wishes to get a ride.

In recent years, safe driving assistance wireless systems utilizing ITS (Intelligent Transport System) have been practically used. Furthermore, studies have been in progress for the practical use of self-driving systems for assisting the driving of autonomous vehicles, in particular, by utilizing ITS communications in such systems. By utilizing ITS communications in such a self-driving system so that various types of information can be exchanged through communications between vehicles (vehicle-to-vehicle communications) and between a roadside apparatus on the road and vehicles (roadside-to-vehicle communications), the system can provide assistance for travel control of autonomous vehicles.

Examples of such technologies for providing assistance for travel control of autonomous vehicles include a system configured such that, when a vehicle delivers packages to multiple delivery locations from one location to another, the system determines an optimal direction of parking at each parking location in consideration of the next parking location, and provides guidance for the direction of parking to the vehicle, thereby enabling smooth delivery without undesirable U-turns or K-turns (Patent Document 1); and a system used in an autonomous vehicle (taxi) for providing guidance to passengers so as to allow them to safely get on/out of the vehicle at certain taxi berths (Patent Document 2).
Patent Document 1: JP2008-027100A
Patent Document 2: JP2017-091400A

### SUMMARY OF THE INVENTION

### Task to be Accomplished by the Invention

In the case of a taxi dispatching system configured to detect a vehicle waiting person who wishes to get a ride and dispatch a taxi for the vehicle waiting person, when a vehicle is located near a vehicle waiting person, but is in a lane on the opposite side of a lane closest to the vehicle waiting person, the vehicle cannot pick up the person until the vehicle makes a U-turn or the person crosses the road to the opposite side. However, a vehicle may not always be allowed to make a U-turn. Moreover, there are some cases where it is hard for a vehicle waiting person to cross the road to the opposite side, such as when a vehicle waiting person is an elderly person and needs to cross a road with a large width, placing a significant burden on the vehicle waiting person.

However, the above-described systems of the prior art do not consider any cases where a vehicle waiting person is located on the opposite side of a road to a lane in which a vehicle is travelling. As a result, there has been a problem that, when a vehicle waiting person walks to and a vehicle travels to a pickup point according to the instruction from such a system, a significant burden of moving to the pickup point is placed on either the vehicle waiting person or the vehicle, which renders the system less convenient.

The present disclosure has been made in view of the problem of the prior art, and a primary object of the present disclosure is a vehicle dispatching method, an in-vehicle device, and a roadside device, which can implement a more convenient system that reduces a burden on a vehicle waiting person and a vehicle.

### Means to Accomplish the Task

An aspect of the present disclosure provides a vehicle dispatching method, wherein a roadside device provided on a road performs following operations: to detect a vehicle waiting person on the road who wishes to get a vehicle ride, and acquires position data of the vehicle waiting person; to set a pickup point based on the position data of the vehicle waiting person and map data, and acquires position data of the pickup point; and to transmit the position data of the pickup point to a server device, wherein the server device performs following operations: to perform a dispatching operation for selecting a vehicle to be allocated for the vehicle waiting person, according to a positional relationship between the vehicle and the pickup point acquired based on the position data of the pickup point; and to transmit the position data of the pickup point to an in-vehicle device mounted in the selected vehicle, and wherein, when a controlling device, the controlling device being either the in-vehicle device or the roadside device, determines, based on the position data of the pickup point and the map data, that a lane closest to the pickup point is for the same traveling direction as a lane in which the selected vehicle is traveling, the controlling device controls the selected vehicle so that the selected vehicle moves to the pickup point.

Another aspect of the present disclosure provides an in-vehicle device comprising: a communication device; a memory; and a processor, wherein the communication device is configured to receive position data of a pickup point, where a vehicle waiting person who wishes to get a vehicle ride is to be picked up, from a server device configured to perform a dispatching operation for selecting a vehicle to be allocated for the vehicle waiting person, and wherein, in a case where the in-vehicle device is mounted in a vehicle that is allocated for the vehicle waiting person by the server device, when the processor determines, based on the position data of the pickup point and map data stored in the memory, that a lane closest to the pickup point is for the same traveling direction as a lane in which the vehicle is traveling, the processor controls the vehicle so that the vehicle moves to the pickup point.

Yet another aspect of the present disclosure provides a roadside device comprising: a communication device; a memory; and a processor, wherein the processor is configured to: detect a vehicle waiting person on a road who wishes to get a vehicle ride, and acquire position data of the vehicle waiting person; and set a pickup point based on the position data of the vehicle waiting person and map data stored in the memory, and acquires position data of the pickup point; and wherein the communication device is configured to transmit the position data of the pickup point to a server device, the server device being configured to perform a dispatching operation for selecting a vehicle to be allocated for the vehicle waiting person.

### Effect of the Invention

According to the present disclosure, it is possible to set a pickup point such that a vehicle waiting person does not need to cross a road while walking to the pickup point and a vehicle does not need to make a U-turn or an undesirable course change while traveling to the pickup point. This reduces a burden on a vehicle waiting person and a vehicle, resulting in that a system can be made more convenient.

### BRIEF DESCRIPTION OF THE DRAWINGS

FIG. 1 is a diagram showing a general configuration of a taxi dispatching system according to a first embodiment of the present disclosure;

FIG. 2 is an explanatory diagram showing an outline of the taxi dispatching system according to the first embodiment;

FIG. 3 is an explanatory diagram showing a guidance screen displayed on a display 6 according to the first embodiment;

FIG. 4 is a block diagram showing a schematic configuration of a roadside apparatus 4 according to the first embodiment;

FIG. 5 is a block diagram showing a schematic configuration of a server 5 according to the first embodiment;

FIG. 6 is a block diagram showing a schematic configuration of an in-vehicle terminal 2 according to the first embodiment;

FIG. 7 is a sequence diagram showing a procedure of operations performed by a roadside apparatus 4 according to the first embodiment;

FIG. 8 is a sequence diagram showing a procedure of operations performed by a server 5 according to the first embodiment;

FIG. 9 is a sequence diagram showing a procedure of operations performed by an in-vehicle terminal 2 according to the first embodiment;

FIG. 10 is an explanatory diagram showing an outline of a taxi dispatching system according to a second embodiment of the present disclosure;

FIG. 11 is a block diagram showing a schematic configuration of an in-vehicle terminal 2 according to the second embodiment;

FIG. 12 is a sequence diagram showing a procedure of operations performed by an in-vehicle terminal 2 according to the second embodiment;

FIG. 13 is an explanatory diagram showing an outline of a taxi dispatching system according to a third embodiment of the present disclosure;

FIG. 14 is a block diagram showing a schematic configuration of an in-vehicle terminal 2 according to the third embodiment;

FIG. 15 is a sequence diagram showing a procedure of operations performed by an in-vehicle terminal 2 according to the third embodiment:

FIG. 16 is an explanatory diagram showing an outline of a taxi dispatching system according to a fourth embodiment of the present disclosure;

FIG. 17 is a block diagram showing a schematic configuration of an in-vehicle terminal 2 according to the fourth embodiment:

FIG. 18 is a sequence diagram showing a procedure of operations performed by an in-vehicle terminal 2 according to the fourth embodiment:

FIG. 19 is an explanatory diagram showing an outline of a taxi dispatching system according to a fifth embodiment of the present disclosure:

FIG. 20 is a block diagram showing a schematic configuration of an in-vehicle terminal 2 according to the fifth embodiment; and

FIG. 21 is a sequence diagram showing a procedure of operations performed by an in-vehicle terminal 2 according to the fifth embodiment.

### DESCRIPTION OF THE PREFERRED EMBODIMENT(S)

A first aspect of the present disclosure made to achieve the above-described object is a vehicle dispatching method, wherein a roadside device provided on a road performs following operations: to detect a vehicle waiting person on the road who wishes to get a vehicle ride, and acquires position data of the vehicle waiting person; to set a pickup point based on the position data of the vehicle waiting person and map data, and acquires position data of the pickup point; and to transmit the position data of the pickup point to a server device, wherein the server device performs following operations: to perform a dispatching operation for selecting a vehicle to be allocated for the vehicle waiting person, according to a positional relationship between the vehicle and the pickup point acquired based on the position data of the pickup point; and to transmit the position data of the pickup point to an in-vehicle device mounted in the selected vehicle, and wherein, when a controlling device, the controlling device being either the in-vehicle device or the roadside device, determines, based on the position data of the pickup point and the map data, that a lane closest to the pickup point is for the same traveling direction as a lane in which the selected vehicle is traveling, the controlling device controls the selected vehicle so that the selected vehicle moves to the pickup point.

According to this configuration, it is possible to set a pickup point such that a vehicle waiting person does not need to cross a road while walking to the pickup point and a vehicle does not need to make a U-turn or a undesirable course change while traveling to the pickup point. This reduces a burden on a vehicle waiting person and a vehicle, resulting in that a system can be made more convenient.

A second aspect of the present disclosure is the vehicle dispatching method of the first aspect, wherein, when the controlling device determines that the lane closest to the pickup point is not for the same traveling direction as the lane in which the selected vehicle is traveling, the controlling device transmits to the server device a no-pickup notification indicating that the selected vehicle is unable to pick up the vehicle waiting person, and wherein, upon receiving the no-pickup notification, the server device re-performs the dispatching operation.

In this configuration, it is possible to allocate a vehicle which is traveling in a lane for the same traveling direction as a lane closest to the pickup point, to a vehicle waiting person even when the allocated vehicle is remote from the vehicle waiting person.

A third aspect of the present disclosure is the vehicle dispatching method of the first aspect, wherein, when the controlling device determines that the lane closest to the pickup point is not for the same traveling direction as the lane in which the selected vehicle is traveling, and also determines, based on the position data of the pickup point and the map data, that the vehicle waiting person can cross the road and move to a second pickup point on the side of the opposite lane, the controlling device controls the selected vehicle so that the selected vehicle moves to the second pickup point.

In this configuration, when a vehicle waiting person can move to a pickup point located along the opposite lane, a closer vehicle is made to travel toward the pickup point even if the vehicle is in the opposite lane. Thus, the vehicle waiting person can get a ride earlier.

A fourth aspect of the present disclosure is the vehicle dispatching method of the first aspect, wherein, when the controlling device determines, based on the position data of the pickup point, the position data of the selected vehicle, and the map data, that the selected vehicle has already passed the pickup point, the controlling device transmits to the server device a no-pickup notification indicating that the selected vehicle is unable to pick up the vehicle waiting person.

This configuration selects a vehicle which can reach a pickup point by traveling straight ahead without making any course change such as a U-turn, and allows the selected vehicle to pick up a vehicle waiting person, which reduces a burden on the vehicle.

A fifth aspect of the present disclosure is the vehicle dispatching method of the first aspect, wherein the controlling device determines, based on the position data of the pickup point, the position data of the selected vehicle, and the map data, that there is a walking obstruction event which hinders the vehicle waiting person walking therethrough, in a moving route from the vehicle person's current position to the pickup point, the controlling device transmits to the server device a no-pickup notification indicating that the selected vehicle is unable to pick up the vehicle waiting person.

This configuration can prevent a vehicle waiting person (in particular, an elderly person) from feeling burdened, for example, by being requested to cross a road with a large width.

A sixth aspect of the present disclosure is the vehicle dispatching method of the first aspect, wherein, when the controlling device determines, based on the position data of the pickup point, the position data of the selected vehicle, the map data, and traffic information, that there is a traveling obstruction event which hinders the selected vehicle traveling therethrough, in a moving route from the selected vehicle's current position to the pickup point, the controlling device transmits to the server device a no-pickup notification indicating that the selected vehicle is unable to pick up the vehicle waiting person.

This configuration can prevent a significantly long wait time required for a vehicle waiting person to get a ride, because it takes a long time for a vehicle to pass through a congested area and reach a pickup point, for example.

A seventh aspect of the present disclosure is the vehicle dispatching method of the first aspect, wherein the roadside device performs following operations: to detect the vehicle waiting person on the road based on one or more images captured by a camera; to extract a captured image of the vehicle waiting person from the images captured by the camera; and to display the captured image of the vehicle waiting person on a display device that can be viewed by the vehicle waiting person.

This configuration allows a vehicle waiting person to confirm that the vehicle waiting person's request has been accepted.

An eighth aspect of the present disclosure is the vehicle dispatching method of the first aspect, wherein the roadside device performs following operations: to detect the vehicle waiting person on the road based on one or more images captured by a camera; to extract a captured image of the pickup point from the images captured by the camera; and to display the captured image of the pickup point on a display device that can be viewed by the vehicle waiting person.

This configuration allows a vehicle waiting person to confirm where a pickup point is located.

A ninth aspect of the present disclosure is the vehicle dispatching method of the first aspect, wherein the roadside device performs following operations: to detect the vehicle waiting person on the road based on one or more images captured by a camera; to extract a captured image of the vehicle waiting person from the images captured by the camera; and to transmit the captured image of the vehicle waiting person directly or through the server device to the in-vehicle device, and wherein the in-vehicle device confirms the vehicle waiting person based on the captured image of the vehicle waiting person.

This configuration allows a vehicle to confirm whether or not a person at a pickup point is a true vehicle waiting person who has made a request to dispatch a vehicle.

A tenth aspect of the present disclosure is an in-vehicle device comprising: a communication device; a memory; and a processor, wherein the communication device is configured to receive position data of a pickup point, where a vehicle waiting person who wishes to get a vehicle ride is to be picked up, from a server device configured to perform a dispatching operation for selecting a vehicle to be allocated for the vehicle waiting person, and wherein, in a case where the in-vehicle device is mounted in a vehicle that is allocated for the vehicle waiting person by the server device, when the processor determines, based on the position data of the pickup point and map data stored in the memory, that a lane closest to the pickup point is for the same traveling direction as a lane in which the vehicle is traveling, the processor controls the vehicle so that the vehicle moves to the pickup point.

This configuration can reduce a burden on a vehicle waiting person and a vehicle, thereby allowing a system to be made more convenient in the same manner as the first aspect.

An eleventh aspect of the present disclosure is a roadside device comprising: a communication device; a memory; and a processor, wherein the processor is configured to: detect a vehicle waiting person on a road who wishes to get a vehicle ride, and acquire position data of the vehicle waiting person; and set a pickup point based on the position data of the vehicle waiting person and map data stored in the memory, and acquires position data of the pickup point; and wherein the communication device is configured to transmit the position data of the pickup point to a server device, the server device being configured to perform a dispatching operation for selecting a vehicle to be allocated for the vehicle waiting person. This configuration allows a server device to perform a dispatching operation in a proper manner.

A twelfth aspect of the present disclosure is the roadside device of the eleventh aspect, wherein, when the processor determines, based on the position data of the pickup point and the map data stored in the memory, that a lane closest to the pickup point is for the same traveling direction as a lane in which the vehicle selected by the server device is traveling, the processor controls the vehicle so that the vehicle moves to the pickup point.

This configuration can reduce a burden on a vehicle waiting person and a vehicle, thereby allowing a system to be made more convenient in the same manner as the first aspect.

Embodiments of the present disclosure will be described below with reference to the drawings.

### First Embodiment

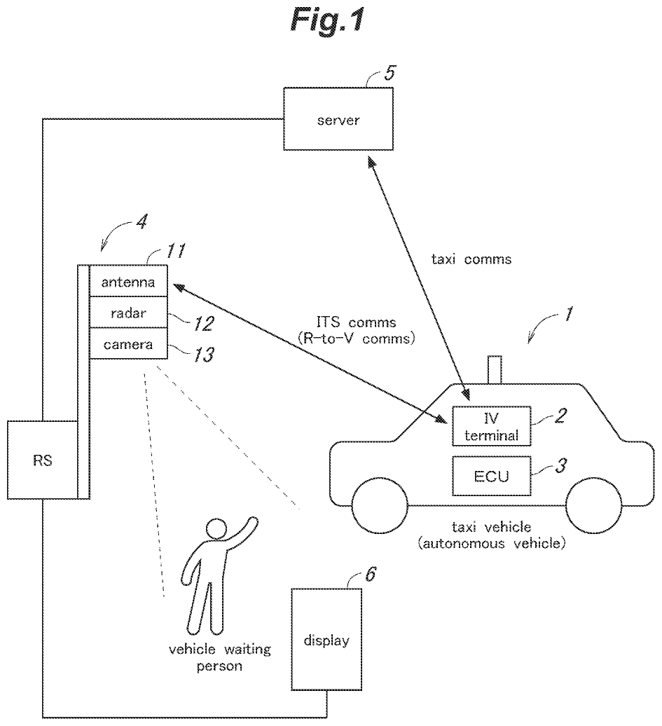

FIG. 1 is a diagram showing a general configuration of a taxi dispatching system according to a first embodiment of the present disclosure.

The taxi dispatching system dispatches a vehicle 1 (autonomous vehicle) used as a taxi and includes: elements mounted in the vehicle 1, i.e., an in-vehicle terminal 2 (in-vehicle device) and an autonomous driving ECU 3 (mobile controller, cruise controller); a roadside apparatus 4 (roadside device); and a server 5 (server device).

The in-vehicle terminal 2 and the roadside apparatus 4 perform ITS communications with each other. ITS communications are performed using frequency bands adopted by ITS-based (i.e., using Intelligent Transport System) safe driving assistance wireless systems (for example, 700 MHz band or 5.8 GHz band). Messages including necessary information such as position data of vehicles are transmitted and received between such terminals and roadside apparatuses through ITS communications.

As used herein, “vehicle-to-vehicle communications” refer to ITS communications performed between in-vehicle terminals 2, “roadside-to-vehicle communications” refer to communications performed among roadside apparatuses 4 and in-vehicle terminals 2. In-vehicle terminal 2 and roadside apparatuses 4 can perform ITS communications with pedestrian terminals (not shown); that is, can perform pedestrian-to-vehicle communications and roadside-to-pedestrian communications.

An in-vehicle terminal 2 transmits and receives a message including position data to and from another in-vehicle terminal 2 through ITS communications (vehicle-to-vehicle communications), and determines a risk of collision between the vehicles. When determining that there is a risk of collision, the in-vehicle terminal 2 performs an alert operation for the driver. The alert operation is preferably performed using a car navigation device connected to the in-vehicle terminal 2. Furthermore, the in-vehicle terminal 2 transmits and receives messages to and from a pedestrian terminal through ITS communications (pedestrian-to-vehicle communications), and determines a risk of collision between the pedestrian and the vehicle.

Furthermore, the in-vehicle terminal 2 is configured to communicate with the server 5 through a wireless communication network dedicated to taxis or a general cellular communication network.

The roadside apparatus 4 notifies in-vehicle terminals 2 and pedestrian terminals that there are a vehicle 1 and a pedestrian around the roadside apparatus 4 through ITS communications (roadside-to-vehicle communications, and roadside-to-pedestrian communications), which can prevent a collision when a vehicle turns left or right at an intersection outside the line of sight. In addition, the roadside apparatus 4 can deliver traffic information to pedestrian terminals 1 and in-vehicle terminals 2.

The roadside apparatus 4 includes an antenna 11, a radar 12, and a camera 13. The antenna 11 transmits and receives radio waves for ITS communications. The radar 12 detects a mobile body (pedestrian or vehicle) located on the road(s) around the roadside apparatus by detecting the reflected waves of the radiated radio waves, to thereby measure the direction and distance of the mobile body from the roadside apparatus. The camera 13 captures images of a road(s) around the roadside apparatus, and can acquire position data of each mobile body located on the road through image recognition performed on the captured image.

A display 6 (display device) is connected to the roadside apparatus 4. The display 6 displays a guidance screen related to taxi dispatching. The display 6 may be configured to usually reproduce contents such as advertisements as digital signage.

The autonomous driving ECU 3 detects an obstacle around the vehicle 1 based on outputs of a sensor (not shown), and also detects a state of the vehicle 1 to perform travel control of the vehicle 1.

The server 5 is generally operated by a taxi operator company, installed in a vehicle dispatcher center, and performs operations related to dispatching of a vehicle 1 used as a taxi. This server 5 collects position data of each vehicle and constantly recognizes where each vehicle is located. The server 5 selects a vehicle to be dispatched for a vehicle waiting person (i.e., a person who wishes to get a vehicle ride) and instructs the vehicle to move to a pickup point near the vehicle waiting person.

In the present embodiment, the roadside apparatus 4 detects a person who performs a predetermined action for requesting to dispatch a vehicle, e.g., raising a hand on the road, as a vehicle waiting person; accepts the vehicle waiting person's request; and then instructs the server 5 to allocate a vehicle for the vehicle waiting person. This system allows a vehicle waiting person to make a request to dispatch a vehicle simply by raising their hand. The roadside apparatus 4 detects the predetermined action performed by a vehicle waiting person based on a detection result of the radar 12 and a result of image recognition performed on images captured by the camera 13.

As described above, the roadside apparatus 4 can detect a person as a vehicle waiting person through recognizing that the person performs the predetermined action through image recognition performed on images captured by the camera 13. However, a technology used to detect a vehicle waiting person is not limited to image recognition performed on images captured by the camera 13. For example, a vehicle waiting person may be detected based on a detection result of another sensor. Furthermore, the predetermined action for requesting to dispatch a vehicle is not limited to raising a hand. For example, the roadside apparatus 4 may be configured to recognize putting an arm out to the side and waving a hand as actions for requesting to dispatch a vehicle as well.

In the present embodiment, the roadside apparatus 4 sets a pickup point at which a vehicle can be parked and a vehicle waiting person can safely get on the vehicle. The roadside apparatus 4 performs this setting operation based on a detection result of the radar 12, a result of image recognition performed on images captured by the camera 13, and map data stored in the roadside apparatus. The roadside apparatus 4 also acquires a moving route for a vehicle waiting person; that is, a route from the current position of the vehicle waiting person to a pickup point. Then, the roadside apparatus 4 displays a guidance screen indicating the moving route for the vehicle waiting person on the display 6. The map data contains at least road-structure-related information (such as information on centerlines, and boundaries), and is sufficiently detailed to the extent the system can determine a lane in which a vehicle is traveling from position data of the vehicle.

Although, in the present embodiment, a taxi is an autonomous vehicle, a taxi vehicle used in this system is not limited to an autonomous vehicle, and the system may be used for a general vehicle manually operated by a driver. The present embodiment can also be applied to an on-demand bus or other type of vehicle. In such cases, necessary information may be displayed on a display such as a car navigation device mounted in the vehicle.

In the present embodiment, a pickup point is displayed on the display 6 so that the pickup point is presented to a vehicle waiting person. However, a projection mapping device may be used to project a mark image representing a pickup point onto the road surface to thereby present the pickup point to a vehicle waiting person. Alternatively, embedded lights may be provided in a row at regular intervals on the road so that the light located at a pickup point can be turned on in a predetermined color to thereby present the pickup point to a vehicle waiting person.

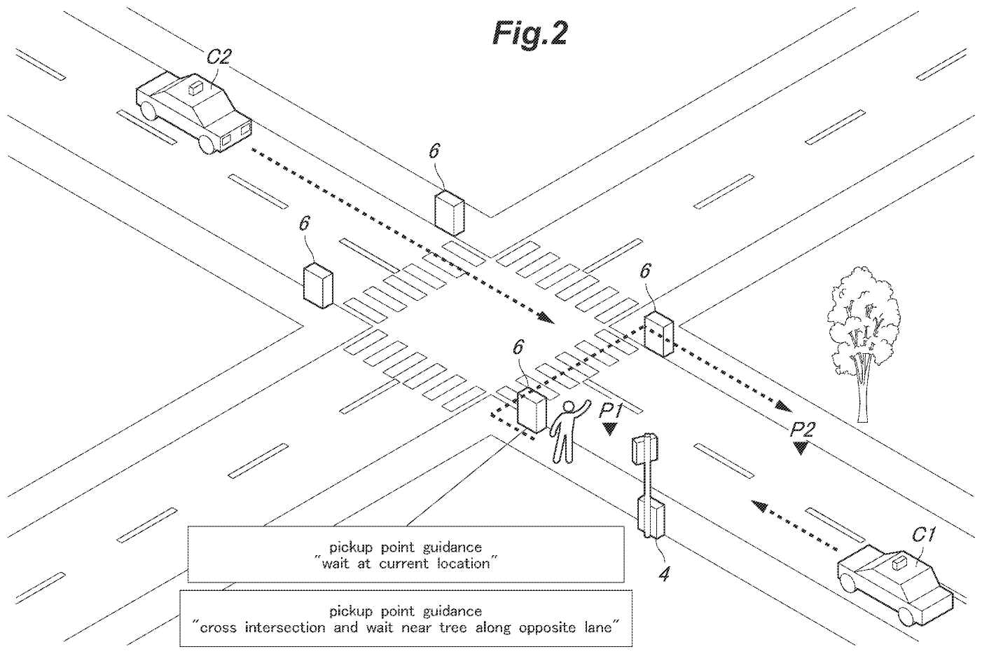

Next, an outline of the taxi dispatching system according to the first embodiment will be described. FIG. 2 is an explanatory diagram showing an outline of the taxi dispatching system.

When a vehicle is located near a vehicle waiting person, but is in a lane on the opposite side of the vehicle waiting person, the vehicle cannot pick up the person until the vehicle makes a U-turn or the person crosses the road to the opposite side. However, a vehicle may not always be allowed to make a U-turn. Moreover, there are some cases where it is hard for a vehicle waiting person to cross the road to the opposite side. For example, when a vehicle waiting person is an elderly person and a width of the road is large, the vehicle waiting person can feel significantly burdened while moving to the pickup point.

In this view, in the present embodiment, the system is configured such that the roadside apparatus 4 sets a proper pickup point near a vehicle waiting person, and the server 5 selects a vehicle near the pickup point by performing a dispatching operation; i.e., an operation for selecting a vehicle to be allocated for the vehicle waiting person. Then, when the in-vehicle terminal 2 determines that a lane closest to the pickup point is for the same traveling direction as a lane in which the vehicle is traveling, the in-vehicle terminal performs control so that the vehicle picks up the vehicle waiting person. However, when the in-vehicle terminal 2 determines that a lane closest to the pickup point is not for the same traveling direction as a lane in which the vehicle is traveling, the in-vehicle terminal 2 transmits a no-pickup notification indicating that the vehicle is unable to pick up the vehicle waiting person, causing the server 5 to re-perform the dispatching operation.

In the present embodiment, when the server 5 fails to find a proper vehicle to be allocated for the vehicle waiting person through the vehicle dispatching operation, the server 5 transmits a no-dispatched notification indicating the server 5 has been unable to dispatch a vehicle, to the roadside apparatus 4, causing the roadside apparatus 4 to re-perform an operation of setting a pickup point (pickup point setting operation). When there is no vehicle in the lane opposite to a vehicle waiting person and the vehicle waiting person can cross the road without any difficulty, the roadside apparatus 4 may set a proper location on the side of the opposite lane as a pickup point.

In the example shown in FIG. 2, when a vehicle C1 is near a vehicle waiting person, the roadside apparatus 4 sets a pickup point P1. In this case, the vehicle waiting person waits for the vehicle near the pickup point P1. The vehicle C1 travels straight ahead toward the pickup point P1. When a vehicle C2 is near the vehicle waiting person, the roadside apparatus 4 sets a pickup point P2 and the vehicle waiting person needs to cross the road to the pickup point P2.

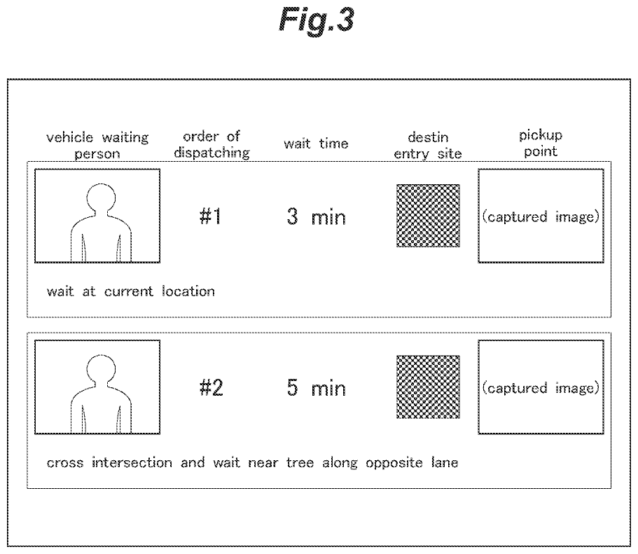

Next, a guidance screen displayed on the display 6 according to the first embodiment. FIG. 3 is an explanatory diagram showing a guidance screen displayed on the display 6.

A guidance screen is displayed on the display 6. This guidance screen includes, for each vehicle waiting person, a captured image of the vehicle waiting person, an order of dispatching vehicle, a wait time, a two-dimensional code for a website for destination entry, a pickup point guidance image, and a guidance message for each vehicle waiting person.

The captured image of the vehicle waiting person is extracted from images captured by the camera 13 through person detection. This allows the vehicle waiting person to confirm that their request to dispatch a vehicle has been accepted.

The order of dispatching vehicle indicates the number given in order of accepted requests to dispatch, made by the predetermined action for requesting to dispatch (e.g., raising a hand). When the vehicle waiting person gets a ride and the vehicle dispatching is completed, the vehicle waiting person is excluded from the numbered list of requests.

The wait time indicates a time required for the allocated vehicle to arrive at the pickup point. The wait time is calculated by the server 5 during the dispatching operation for selecting a vehicle to be allocated for the vehicle waiting person, and transmitted to the roadside apparatus 4.

The two-dimensional code for a website for destination entry represents a URL or address of a website for destination entry. The vehicle waiting person can access the website for destination entry by having a user terminal (such as a smartphone) read the two-dimensional code and enter the destination, to thereby notify the server 5 of the destination. This allows the server 5 to select a proper vehicle for the vehicle waiting person in consideration of the destination.

The pickup point guidance image provides a guidance related to the pickup point to the vehicle waiting person. In the example shown in FIG. 3, a captured image of pickup point extracted from images captured by the camera 13 is displayed. Preferably, an arrow mark pointing to the pickup point is displayed in the captured image of the pickup point. When the pickup point is remote from the current position of the vehicle waiting person, a line or other mark representing the moving route from the current position of the vehicle waiting person to the pickup point may be displayed in the map.

The guidance message is a text message that explains the moving route from the current position of the vehicle waiting person to the pickup point. In the guidance message, an object that serves as a visual landmark (such as a tree) is used to indicate the pickup point. For example, when the pickup point is located near the vehicle waiting person, the screen indicates a guidance message “wait at current position,” and when the vehicle waiting person needs to cross the road, the screen indicates a guidance message “cross intersection and wait near tree along opposite lane.”

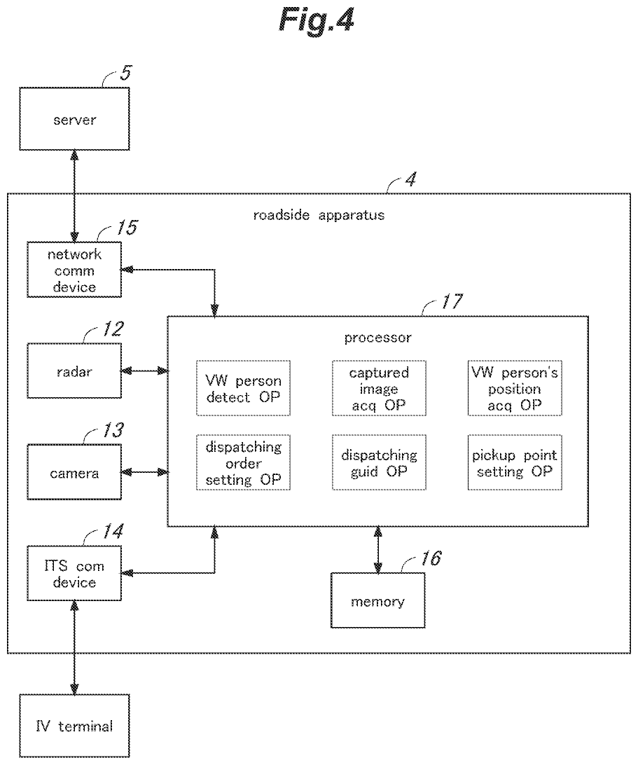

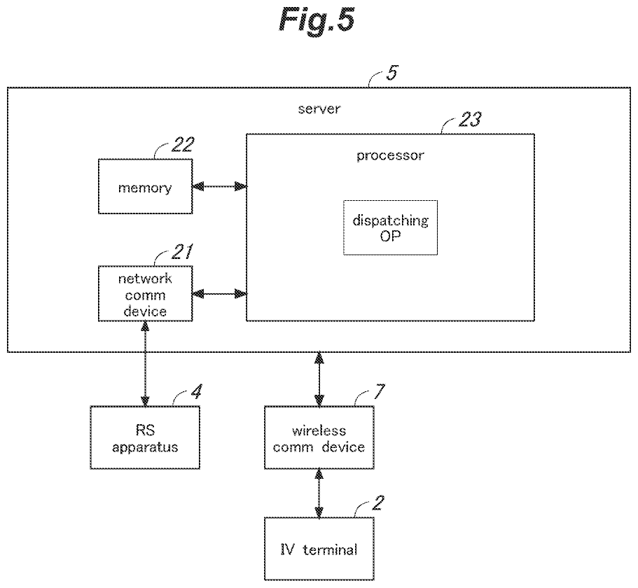

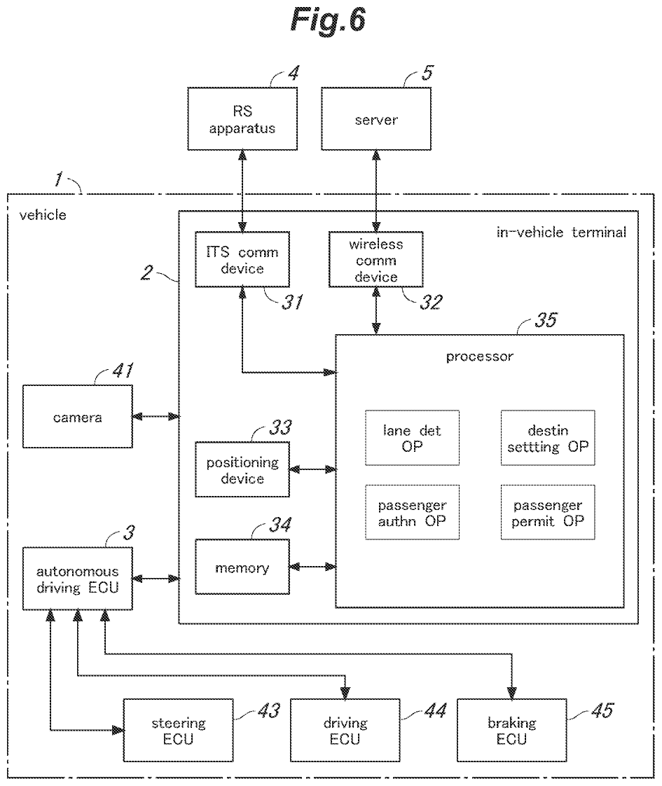

Next, schematic configurations of a roadside apparatus 4, a server 5, and an in-vehicle terminal 2 will be described. FIG. 4 is a block diagram showing a schematic configuration of a roadside apparatus 4. FIG. 5 is a block diagram showing a schematic configuration of a server 5. FIG. 6 is a block diagram showing a schematic configuration of an in-vehicle terminal 2.

As shown in FIG. 4, the roadside apparatus 4 includes an ITS communication device 14, a network communication device 15, a memory 16, and a processor 17, as well as a radar 12 and a camera 13.

The ITS communication device 14 broadcasts messages to in-vehicle terminals 2 through ITS communications (roadside-to-vehicle communications), and also receives messages transmitted from the in-vehicle terminals 2. By having the terminal ID of a destination in-vehicle terminal 2 added to a message to be transmitted, the ITS communication device 14 can transmit the message addressed to the specific in-vehicle terminal 2.

The network communication device 15 communicates with the server 5 via a network.

The memory 16 stores map information, programs executable by the processor 17, and other information.

The processor 17 performs various processing operations by executing the programs stored in the memory 16. In the present embodiment, the processor 17 performs a vehicle waiting person detecting operation, a captured image acquiring operation, a vehicle waiting person's position acquiring operation, a dispatching order setting operation, a dispatching guidance operation, and a pickup point setting operation.

In the vehicle waiting person detecting operation, the processor 17 detects a person on the road who performs an action for requesting to dispatch a vehicle, e.g., raising a hand, as a vehicle waiting person, based on a detection result of the radar 12 and a result of image recognition performed on images captured by the camera 13.

In the captured image acquiring operation, the processor 17 cuts out an image area of the vehicle waiting person from an image captured by the camera 13 to acquire the captured image of the vehicle waiting person. In the captured image acquiring operation, the processor 17 also cuts out an image area of the pickup point from an image captured by the camera 13 to acquire the captured image of the pickup point.

In the vehicle waiting person's position acquiring operation, the processor 17 acquires position data (latitude, longitude) of the vehicle waiting person based on the distance from the roadside apparatus to the vehicle waiting person and the orientation of the vehicle waiting person as viewed from the roadside apparatus, where the distance and the orientation are determined from a detection result of the radar 12 and a result of image recognition performed on images captured by the camera 13.

In the dispatching order setting operation, the processor 17 sets the dispatching order for the vehicle waiting person based on the list of vehicle waiting persons who have requested to dispatch vehicles.

In the dispatching guidance operation, the processor 17 displays the captured image of the vehicle waiting person and the dispatching order for the vehicle waiting person on the display 6. In the dispatching guidance operation, the processor 17 also displays the captured image of the pickup point on the display 6.

In the pickup point setting operation, the processor 17 sets a pickup point based on a detection result of the radar 12, a result of image recognition performed on images captured by the camera 13 and the map data stored in the memory 16. Specifically, the processor 17 first searches for pickup point candidates at which a vehicle can be parked and a vehicle waiting person can safely get on the vehicle. When finding one pickup point candidate, the processor 17 sets the point as a pickup point. When finding multiple pickup point candidates, the processor 17 selects the point closest to the vehicle waiting person among the pickup point candidates and sets the selected point as a pickup point.

As shown in FIG. 5, the server 5 includes a network communication device 21, a memory 22, and a processor 23. The server 5 is connected to the wireless communication device 7, and capable of communicating with the in-vehicle terminal 2 through the wireless communication device 7.

The network communication device 21 communicates with a roadside apparatus 4 via a network.

The memory 22 stores programs executable by the processor 23 and other information.

The processor 23 performs various processing operations by executing the programs stored in the memory 22. In the present embodiment, the processor 23 performs the dispatching operation.

In the dispatching operation, the processor 23 selects a vehicle to be allocated, i.e., dispatched for a vehicle waiting person based on the pickup point's position data acquired from the roadside apparatus 4. In this operation, the processor 23 sets vehicles located in a nearby area of the pickup point as target vehicles to be allocated, based on the position data of the pickup point acquired from the roadside apparatus 4. Then, the processor 23 selects a vehicle to be allocated for the vehicle waiting person, among empty vehicles in the target vehicles, based on a positional relationship between the vehicle and the pickup point. Specifically, the processor 23 selects the vehicle that is closest to the pickup point and allocates the vehicle to the vehicle waiting person.

In the present embodiment, the in-vehicle terminal 2 determines whether or not the vehicle meets predetermined determination criteria (pickup possibility determination operation), and when the vehicle does not meet the determination criteria, the in-vehicle terminal 2 transmits to the server 5 a no-pickup notification indicating that the vehicle cannot pick up a person at the pickup point. Upon receiving the no-pickup notification form the in-vehicle terminal 2, the processor 23 of the server 5 excludes the vehicle from which the no-pickup notification is transmitted, and re-performs the vehicle dispatching operation. Specifically, the processor 23 selects the second vehicle in order of distance from the vehicle waiting person. When further receiving a no-pickup notification, which means that the second vehicle does not meet the determination criteria, the processor 23 selects the next vehicle in the same order, and repeats the operations until a vehicle that meets the determination criteria is found. As a result, a vehicle that is as close to the vehicle waiting person as possible and meets the determination criteria, travels towards the pickup point to pick up the vehicle waiting person.

As shown in FIG. 6, the in-vehicle terminal 2 includes an ITS communication device 31, a wireless communication device 32, a positioning device 33, a memory 34, and a processor 35.

The ITS communication device 31 broadcasts messages to other in-vehicle terminals 2 through ITS communications (vehicle-to-vehicle communications), and also receives messages transmitted from other in-vehicle terminals 2. Furthermore, the ITS communication device 31 transmits and receives messages to and from roadside apparatuses 4 through ITS communications (roadside-to-vehicle communications).

The wireless communication device 32 communicates with the server 5 through a wireless communication network dedicated to taxis or a general cellular communication network.

The positioning device 33 determines the position of the in-vehicle terminal 2 by using a satellite positioning system such as GPS (Global Positioning System) or QZSS (Quasi-Zenith Satellite System), to thereby acquire the position data (latitude, longitude) of the in-vehicle terminal 2.

The memory 34 stores map data, programs executable by the processor 35, and other information.

The processor 35 performs various processing operations related to the taxi dispatching system by executing the programs stored in the memory 34. In the present embodiment, the processor 35 performs a lane determination operation, a destination setting operation, a passenger authentication operation, and a passenger permission operation.

In the lane determination operation, the processor 35 determines whether or not the lane closest to the pickup point is for the same traveling direction as the lane in which the vehicle is traveling, based on position data of the pickup point and traveling lane information. The position data of the pickup point is acquired from the roadside apparatus 4. The traveling lane information, i.e., information on the lane in which the vehicle is traveling may be acquired based on the position data of the vehicle acquired by the positioning device 33 and the map data stored in the memory 34.

In the destination setting operation, the processor 35 provides travel instruction information including the pickup point as a destination to the autonomous driving ECU 3.

In the passenger authentication operation, the processor 35 detects a person located at the pickup point from images captured by a camera 41 mounted in the vehicle, compares the captured image of the person with the captured image of the vehicle waiting person to thereby determine whether or not the person at the pickup point is the vehicle waiting person.

In the passenger permission operation, the processor 35 instructs the vehicle to permit the vehicle waiting person to ride in the vehicle, specifically, instructing the door open/close mechanism to open the door. As a result, the door of the vehicle opens to allow the vehicle waiting person to ride in the vehicle.

The autonomous driving ECU 3 is connected to a steering ECU 43, a driving ECU 44, and a braking ECU 45. Based on detection results of a sensor (not shown), the autonomous driving ECU 3 controls the steering ECU 43, the driving ECU 44, and the braking ECU 45 to implement automatic driving (autonomous driving) of the vehicle 1.

The steering ECU 43 controls the steering mechanism of the vehicle 1, while the driving ECU 44 controls the driving mechanism (such as engine, electric motor) of the vehicle 1. The braking ECU 45 controls the braking mechanism of the vehicle 1.

The types of automatic driving include autonomous driving which does not require a driver, and driving assistance which assists a driver to drive the vehicle, and the system may be configured to operate in either of the switchable operation modes, i.e., the autonomous driving mode and the driving assistance mode. In the case of the driving assistance mode, when there is a risk of collision, the system needs to provide an alert to the driver. For example, the car navigation device may provide an alert to the driver by using voice or image display, based on the control of the in-vehicle terminal 2.

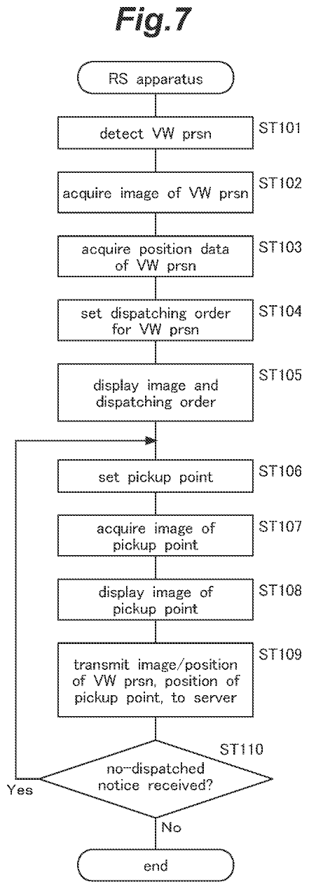

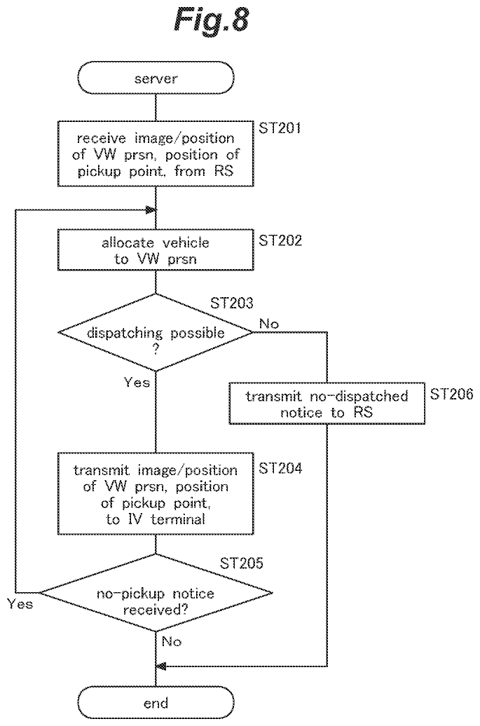

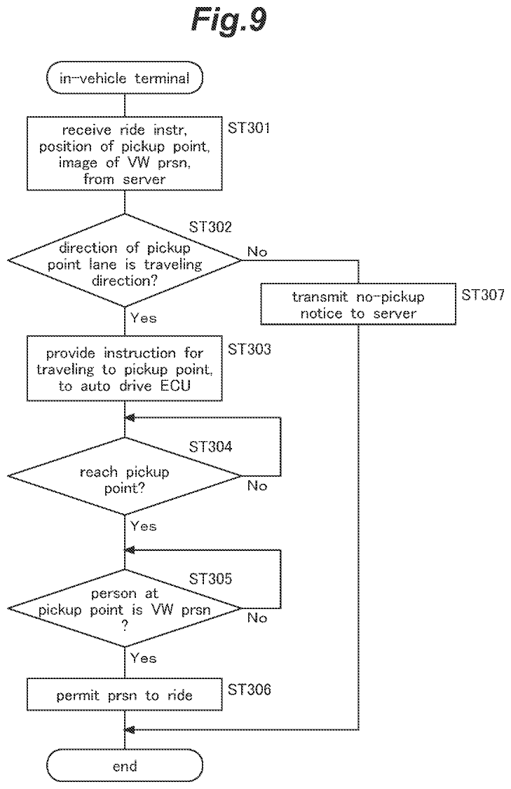

Next, procedures of operations performed by a roadside apparatus 4, a server 5, and an in-vehicle terminal 2 according to the first embodiment will be described. FIG. 7 is a sequence diagram showing a procedure of operations performed by a roadside apparatus 4. FIG. 8 is a sequence diagram showing a procedure of operations performed by a server 5. FIG. 9 is a sequence diagram showing a procedure of operations performed by an in-vehicle terminal 2.

As shown in FIG. 7, in the roadside apparatus 4, the processor 17 first detects a vehicle waiting person raising their hand on the road based on a detection result of the radar 12 and images captured by the camera 13 (vehicle waiting person detection operation) (ST101). Next, the processor 17 cuts out an image area of the vehicle waiting person from the image captured by the camera 13 and acquires the captured image of the vehicle waiting person (captured image acquiring operation) (ST102).

Next, the processor 17 acquires position data (latitude, longitude) of the vehicle waiting person based on the distance from the roadside apparatus to the vehicle waiting person and the orientation of the vehicle waiting person as viewed from the roadside apparatus, where the distance and the orientation are determined from a detection result of the radar 12 and a result of image recognition performed on images captured by the camera 13 (vehicle waiting person's position acquiring operation) (ST103).

Next, the processor 17 sets the dispatching order for the vehicle waiting person based on the list of vehicle waiting persons who have requested to dispatch vehicles. (dispatching order setting operation) (ST104). Then, the processor 17 displays the captured image of the vehicle waiting person and the dispatching order for the vehicle waiting person on the display 6 (dispatching guidance operation) (ST105).

Next, the processor 17 sets a pickup point based on a detection result of the radar 12, a result of image recognition performed on images captured by the camera 13 and the map data stored in the memory 16 (pickup point setting operation) (ST106).

Next, the processor 17 cuts out an image area of the pickup point from the image captured by the camera 13 to acquire the captured image of the pickup point (captured image acquiring operation) (ST107). Then, the processor 17 displays the captured image of the pickup point on the display 6 (dispatching guidance operation) (ST108). Next, the network communication device 15 transmits the captured image of the vehicle waiting person, the position data (latitude, longitude) of the vehicle waiting person, and the position data (latitude, longitude) of the pickup point to the server 5 (ST109).

Next, when the network communication device 15 receives a no-dispatched notification transmitted from the server 5, the process returns ST106, and the processor 17 re-performs the pickup point setting operation.

As shown in FIG. 8, in the server 5, the network communication device 21 receives the captured image of the vehicle waiting person, the position data of the vehicle waiting person, and the position data of the pickup point transmitted from the roadside apparatus 4 (ST201). Next, the processor 23 selects a vehicle that is closest to the vehicle waiting person among empty vehicles in the target vehicles, and allocates the vehicle to the vehicle waiting person (dispatching operation) (ST202).

Next, when the server has successfully dispatched a vehicle (Yes in ST203), the processor 23 performs control so that the wireless communication device 7 can transmit to the in-vehicle terminal 2, pickup instruction information instructing the vehicle to pick up the vehicle waiting person, the pickup point position data (latitude, longitude), and the captured image of vehicle waiting person.

Next, when the server receives a no-pickup notification transmitted from the in-vehicle terminal 2 (Yes in ST205), the process returns to ST202, and the processor 23 re-performs the dispatching operation.

When the server has failed to dispatch a vehicle (No in ST203), the network communication device 21 transmits a no-dispatched notification to the roadside apparatus 4 (ST206).

As shown in FIG. 9, in the in-vehicle terminal 2, the wireless communication device 32 receives the pickup instruction information and the position data of the pickup point, and the captured image of the vehicle waiting person from the server 5 (ST301). Next, the processor 35 determines whether or not a lane closest to the pickup point is for the same traveling direction as the lane in which a vehicle is traveling based on the position data of the pickup point and the traveling lane information on the lane in which the vehicle is traveling (lane determination operation) (ST302).

Then, when determining that the lane closest to the pickup point is for the same traveling direction as the lane in which vehicle is traveling (Yes in ST302), the processor 35 provides travel instruction information including the pickup point as the destination to the autonomous driving ECU 3 (destination setting operation) (ST303). When receiving the travel instruction information from the in-vehicle terminal 2, the autonomous driving ECU 3 performs driving control so that the vehicle moves toward the pickup point designated as the destination by the travel instruction information.

Then, when the vehicle arrives at the pickup point (Yes in ST304), the processor 35 determines whether or not a person at the pickup point is the vehicle waiting person based on the captured image of the vehicle waiting person (passenger authentication operation) (ST305).

When the person at the pickup point is the vehicle waiting person (Yes in ST305), the processor 35 instructs the vehicle to permit the vehicle waiting person to ride in the vehicle, specifically, instructing the door open/close mechanism to open the door (passenger permission operation) (ST306). As a result, the door of the vehicle opens to allow the vehicle waiting person to get a ride.

When determining that a lane closest to the pickup point is not for the same traveling direction as the lane in which vehicle is traveling (No in ST302), the wireless communication device 32 transmits a no-pickup notification to the server 5. Upon receiving the no-pickup notification from the in-vehicle terminal 2, the server 5 re-performs the dispatching operation. Specifically, the processor 23 of the server 5 excludes the vehicle from which the no-pickup notification is transmitted, selects the second vehicle in order of distance from the vehicle waiting person, and allocate the selected vehicle to the vehicle waiting person. When further receiving a no-pickup notification, the processor 23 selects the next vehicle in the same order, and repeats the operations as described above.

In the present embodiment, the system is configured such that an in-vehicle terminal 2 performs the lane determination operation in order to reduce overheads of communications. However, a roadside apparatus 4 may be configured to perform the lane determination operation.

### Second Embodiment

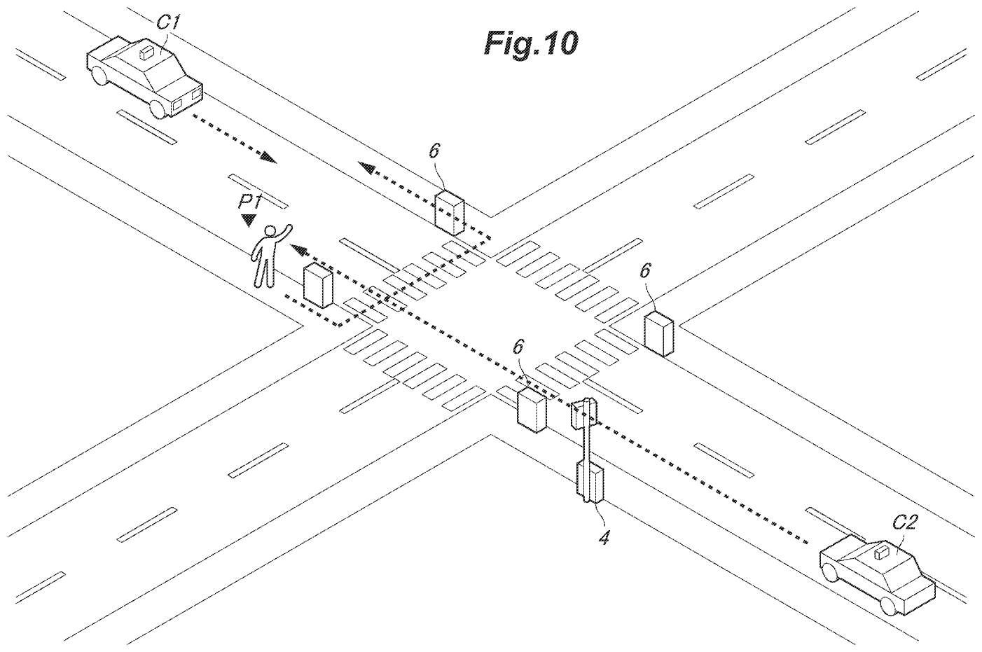

Next, a second embodiment of the present disclosure will be described. Except for what will be discussed here, the second embodiment is the same as the above-described first embodiment. FIG. 10 is an explanatory diagram showing an outline of a taxi dispatching system according to the second embodiment.

When a vehicle waiting person is an elderly person or a handicapped person, crossing a road can be a significant burden on the vehicle waiting person. In particular, in the case of crossing a road with a large width, the vehicle waiting person may be unable to cross the road on a green light, and thus instructing the vehicle waiting person to cross the road is not appropriate. Even in the case of a vehicle waiting person who is not an elderly person or a handicapped person, it can be difficult for the vehicle waiting person to cross the road with no traffic lights or pedestrian crossings nearby.

In this view, in the present embodiment, the system is configured such that, when determining that a lane closest to the pickup point is not for the same traveling direction as a lane in which the vehicle is traveling, the in-vehicle terminal 2 further determines whether or not a vehicle waiting person can cross the road and move to a second pickup point on the side of the opposite lane. Then, when determining that the vehicle waiting person cannot cross the road to the side of the opposite lane, the in-vehicle terminal 2 transmits a no-pickup notification indicating that the vehicle is unable to pick up the vehicle waiting person, to the server 5, causing the server 5 to re-perform the dispatching operation. As a result, the server 5 selects a vehicle traveling in a lane for the same traveling direction as the lane closest to the vehicle waiting person, eliminating the need for the vehicle waiting person to cross the road to the side of the opposite lane, which can reduce a burden on the vehicle waiting person.

When there is no nearby vehicle in the lane closest to a vehicle waiting person and it is determined that a vehicle in the opposite lane can arrive at a point where the vehicle waiting person is located (e.g., by making a U-turn or another course change) earlier than a vehicle traveling in the lane closest to the vehicle waiting person can arrive at the point, the in-vehicle terminal 2 may notify the vehicle in the opposite lane of a request to dispatch a vehicle. In this case, since it is difficult for the vehicle waiting person to cross the road to the side of the opposite lane, the pickup point is set on the side of the lane closest to the vehicle waiting person.

In the example shown in FIG. 10, first, the server 5 performs the dispatching operation and selects a vehicle C1 closest to the pickup point. In the case of the vehicle C1, the vehicle waiting person needs to cross the road. When the vehicle waiting person cannot move across the road to the side of the opposite lane, the in-vehicle terminal 2 transmits a no-pickup notification to the server 5, causing the server 5 to reperform the dispatching operation. As a result, the server selects a vehicle C2 traveling in the lane for the same traveling direction as the lane closest to the vehicle waiting person. In the case of this vehicle C2, the vehicle waiting person does not need to cross the road and can get a ride on the vehicle.

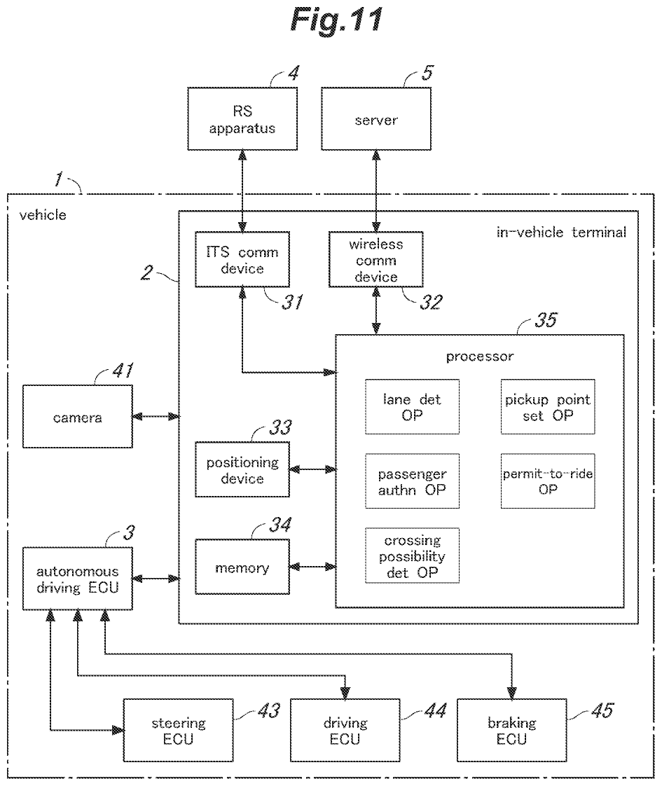

Next, a schematic configuration of an in-vehicle terminal 2 according to the second embodiment will be described. FIG. 11 is a block diagram showing a schematic configuration of an in-vehicle terminal 2 according to the second embodiment. The configurations of the roadside apparatus 4 and the server 5 are the same as those of the first embodiment (FIGS. 4 and 5).

The in-vehicle terminal 2 is substantially the same as that of the first embodiment except that the processor 35 performs a crossing possibility determination operation, in addition to the lane determination operation, the pickup point setting operation, the passenger authentication operation, and the permit-to-ride operation.

In the crossing possibility determination operation, the processor 35 determines whether or not the vehicle waiting person can move across the road to the side of the opposite lane based on the pickup point's position data acquired from the server 5 and the map data stored in the memory 34.

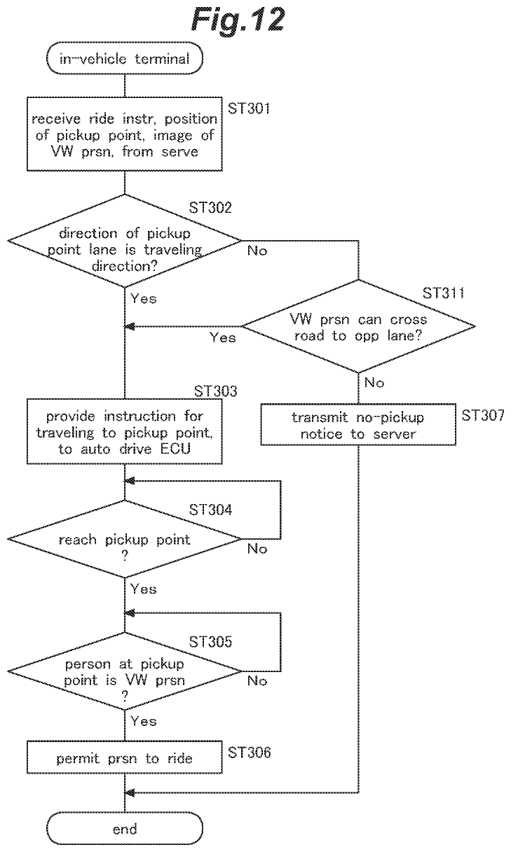

Next, a procedure of operations performed by an in-vehicle terminal 2 according to the second embodiment will be described. FIG. 12 is a sequence diagram showing a procedure of operations performed by an in-vehicle terminal 2. The procedures of operations performed by the roadside apparatus 4 and the server 5 are same as those of the first embodiment (FIGS. 7 and 8).

In the in-vehicle terminal 2, the wireless communication device 32 receives pickup instruction information, the position data of the pickup point, and the captured image of the vehicle waiting person from the server 5 (ST301). Next, the processor 35 determines whether or not a lane closest to the pickup point is for the same traveling direction as the lane in which vehicle is traveling based on the position data of the pickup point and the traveling lane information on the lane in which the vehicle is traveling (lane determination operation) (ST302).

Then, when determining that the lane closest to the pickup point is for the same traveling direction as the lane in which vehicle is traveling (Yes in ST302), the processor 35 provides travel instruction information including the pickup point as the destination to the autonomous driving ECU 3 (destination setting operation) (ST303). The subsequent operations are the same as those of the first embodiment (FIG. 9).

When determining that the lane closest to the pickup point is not for the same traveling direction as the lane in which vehicle is traveling (No in ST302), the processor 35 determines whether or not the vehicle waiting person can cross the road to the side of the opposite lane (crossing possibility determination operation) (ST311).

When the processor determines that the vehicle waiting person can cross the road to the side of the opposite lane (Yes in ST311), the process proceeds to ST303.

When the processor determines that the vehicle waiting person can cross the road to the side of the opposite lane (Yes in ST311), the wireless communication device 32 transmits a no-pickup notification to the server 5 (ST307). Upon receiving the no-pickup notification from the in-vehicle terminal, the server 5 re-performs the dispatching operation.

In the present embodiment, the system is configured such that an in-vehicle terminal 2 performs the lane determination operation and the crossing possibility determination operation in order to reduce overheads of communications. However, a roadside apparatus 4 may be configured to perform the lane determination operation and the crossing possibility determination operation.

### Third Embodiment

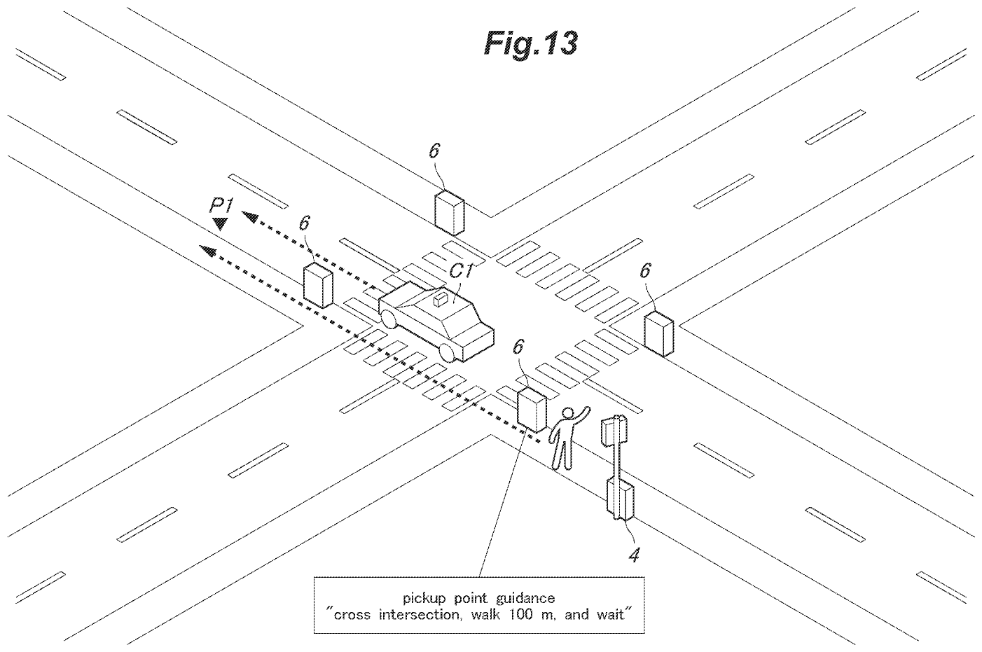

Next, a third embodiment of the present disclosure will be described. FIG. 13 is an explanatory diagram showing an outline of a taxi dispatching system according to the third embodiment.

The roadside apparatus 4 sets a proper pickup point near a vehicle waiting person, and the server 5 selects a vehicle near the pickup point and transmits a pickup instruction to the selected vehicle. In this case, when the selected vehicle has already passed the pickup point, that is, the pickup point is located behind the traveling vehicle, the vehicle needs to make a U-turn or other course change to reach the pickup point, which can be a significant burden on the vehicle.

In this view, in the present embodiment, the system is configured such that, when the selected vehicle has already passed the pickup point and there is no suitable vehicle to replace the selected vehicle, the server 5 transmits a no-dispatched notification indicating that there is no vehicle to be dispatched, to the roadside apparatus 4, which in turn re-performs the pickup point setting operation to set a pickup point located ahead of the traveling vehicle. As a result, the vehicle can reach a pickup point by traveling straight ahead without making any course change such as a U-turn, which can reduce a burden on the vehicle.

In the example shown in FIG. 13, although a vehicle C1 has already passed the point where the vehicle waiting person is located, a roadside apparatus sets a point P1 as a pickup point, allowing the vehicle C1 to reach the pickup point by traveling straight ahead without making any course change such as a U-turn. As the pickup point is located remote from the current potion of the vehicle waiting person, the vehicle waiting person moves toward the pickup point according to guidance indicated in the display 6.

When the pickup point that has been set is too far from the current position of a vehicle waiting person and thus a significant burden is placed on the vehicle waiting person, the system may expand a target area for the dispatching operation to thereby select a vehicle such that a pickup point near the vehicle waiting person is located ahead of the selected vehicle in the traveling direction. As a result, although a wait time becomes longer because of a longer distance between the current position of the vehicle waiting person and the selected vehicle, the vehicle waiting person does not need to walk a long distance, which can reduce a burden on the vehicle waiting person.

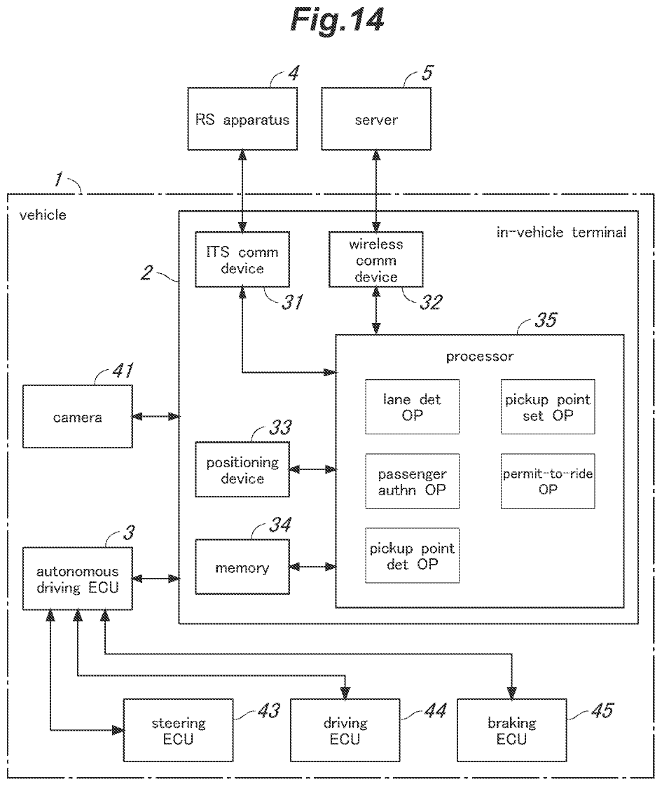

Next, a schematic configuration of an in-vehicle terminal 2 according to the third embodiment will be described. FIG. 14 is a block diagram showing a schematic configuration of an in-vehicle terminal 2. The configurations of the roadside apparatus 4 and the server 5 are the same as those of the first embodiment (FIGS. 4 and 5).

The in-vehicle terminal 2 is substantially the same as that of the first embodiment except that the processor 35 performs a pickup point determination operation, in addition to the lane determination operation, the pickup point setting operation, the passenger authentication operation, and the permit-to-ride operation.

In the pickup point determination operation, the processor 35 determines whether or not a vehicle waiting person has already passed the pickup point; that is, the pickup point is located behind the traveling vehicle, based on the position data acquired by the positioning device 33, the pickup point's position data acquired from the server 5 and the map data stored in the memory 34.

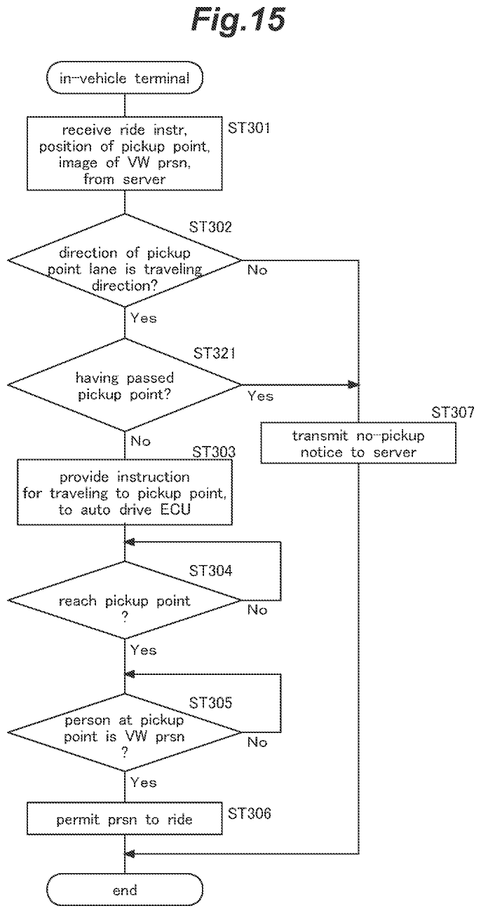

Next, a procedure of operations performed by an in-vehicle terminal 2 according to the third embodiment will be described. FIG. 15 is a sequence diagram showing a procedure of operations performed by an in-vehicle terminal 2 according to the third embodiment. The procedures of operations performed by the roadside apparatus 4 and the server 5 are same as those of the first embodiment (FIGS. 7 and 8).

In the in-vehicle terminal 2, the wireless communication device 32 receives pickup instruction information, the position data of the pickup point, and the captured image of the vehicle waiting person from the server 5 (ST301). Next, the processor 35 determines whether or not a lane closest to the pickup point is for the same traveling direction as the lane in which vehicle is traveling based on the position data of the pickup point and the traveling lane information the lane in which the vehicle is traveling (lane determination operation) (ST302).

Then, when determining that the lane closest to the pickup point is for the same traveling direction as the lane in which vehicle is traveling (Yes in ST302), the processor 35 determines whether or not the vehicle has already passed the pickup point based on the position data acquired by the positioning device 33, the pickup point position data acquired from a roadside apparatus 4, and the map data stored in the memory 34 (pickup point determination operation) (ST321).

When determining that the vehicle has not passed the pickup point (No in ST321), the processor 35 provides travel instruction information including the pickup point as a destination to the autonomous driving ECU 3 (destination setting operation) (ST303). The subsequent operations are the same as those of the first embodiment (FIG. 9).

When the processor determines that the lane closest to the pickup point is not for the same traveling direction as the lane in which vehicle is traveling (No in ST302), or that the vehicle has already passed the pickup point (Yes in ST321), the wireless communication device 32 transmits a no-pickup notification to the server 5 (ST307). Upon receiving the no-pickup notification from the in-vehicle terminal 2, the server 5 re-performs the dispatching operation.

In the present embodiment, the system is configured such that an in-vehicle terminal 2 performs the pickup point determination operation in order to reduce overheads of communications. However, a roadside apparatus 4 may be configured to perform the pickup point determination operation.

### Fourth Embodiment

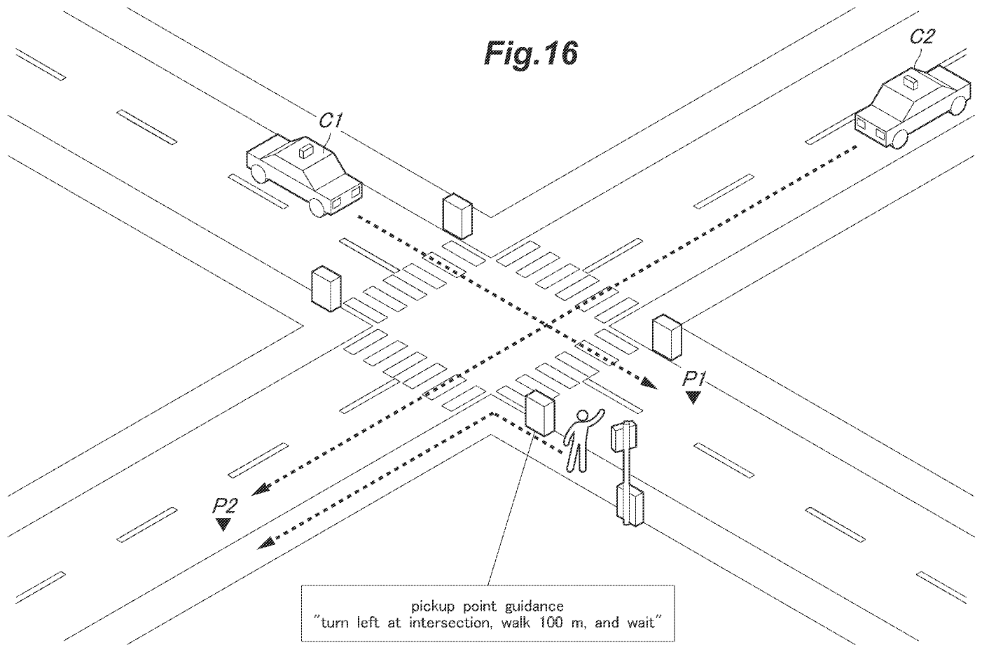

Next, a fourth embodiment of the present disclosure will be described. FIG. 16 is an explanatory diagram showing an outline of a taxi dispatching system according to the fourth embodiment.

A pickup point is desirably set at a point where a vehicle waiting person does not need to cross the road to reach. In particular, in cases where a vehicle waiting person is an elderly person or a handicapped person who can feel burdened when crossing the road, a pickup point needs to be set at a point where a vehicle waiting person does not need to cross the road to reach.

In this view, in the present embodiment, when there are multiple pickup point candidates within a region within which a vehicle waiting person can move, the system sets a pickup point at a point which is remote from the current position of the vehicle waiting person, but located such that the vehicle waiting person does not need to cross the road to reach. This can prevent a vehicle waiting person (in particular, an elderly person or a handicapped person) from feeling burdened when moving to the pickup point.

In the example shown in FIG. 16, first, a roadside apparatus 4 sets a point P1 as a pickup point, and selects a vehicle C1 closest to the pickup point. In the case of the vehicle C1, the vehicle waiting person needs to cross the road. When the vehicle waiting person cannot move across the road to the side of the opposite lane, the in-vehicle terminal 2 transmits a no-pickup notification to the server 5, causing the server 5 to reperform the dispatching operation. When the server 5 still cannot dispatch a proper vehicle for the vehicle waiting person, the in-vehicle terminal causes a roadside apparatus 4 to re-perform the pickup point setting operation to set a point P2 as a pickup point, and select the vehicle C2. As the pickup point is located remote from the current position of the vehicle waiting person, the vehicle waiting person needs to move toward the pickup point according to guidance indicated in the display 6.

In the present embodiment, the system is configured to select a pickup point at a point where a vehicle waiting person does not need to cross the road to reach. However, when such a point for a pickup point is not found, the system may select a point where the vehicle waiting person can reach by crossing as few roads as possible. In other cases, the system may select a point where a vehicle can reach by making as few turns (right or left turns) as possible.

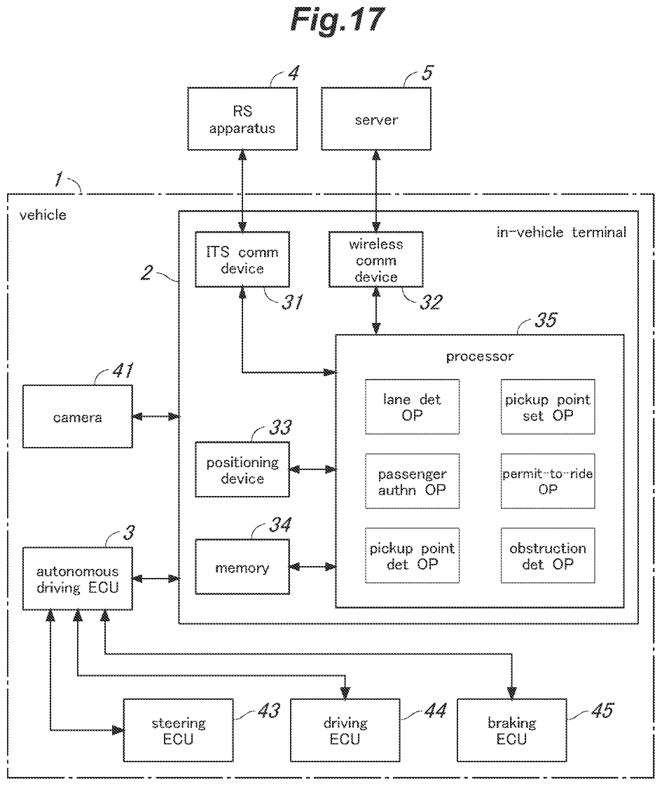

Next, a schematic configuration of an in-vehicle terminal 2 according to the fourth embodiment will be described. FIG. 17 is a block diagram showing a schematic configuration of an in-vehicle terminal 2. The configurations of the roadside apparatus 4 and the server 5 are the same as those of the first embodiment (FIGS. 4 and 5).

The in-vehicle terminal 2 is substantially the same as that of the first embodiment except that the processor 35 performs the pickup point determination operation and a walking obstruction determination operation, in addition to the lane determination operation, the pickup point setting operation, the passenger authentication operation, and the permit-to-ride operation. The pickup point determination operation is the same as that of the third embodiment.

In the walking obstruction determination operation, first, the processor 35 acquires a moving route for a vehicle waiting person; that is, the optimum moving route (walking route) from the vehicle person's current position to the pickup point. The processor may perform this operation based on the position data of the vehicle waiting person acquired from the roadside apparatus 4 and the pickup point's position data, and the map data stored in the memory 34.

Next, the processor 35 determines whether or not there is a walking obstruction event which hinders the vehicle waiting person walking therethrough, in the vehicle waiting person's moving route. As used herein, the term “walking obstruction event” refers to a case in which a vehicle waiting person who has difficulty with walking such as an elderly person, can feel burdened to walk through, for example, a case where a vehicle waiting person needs to cross a road with a large width.

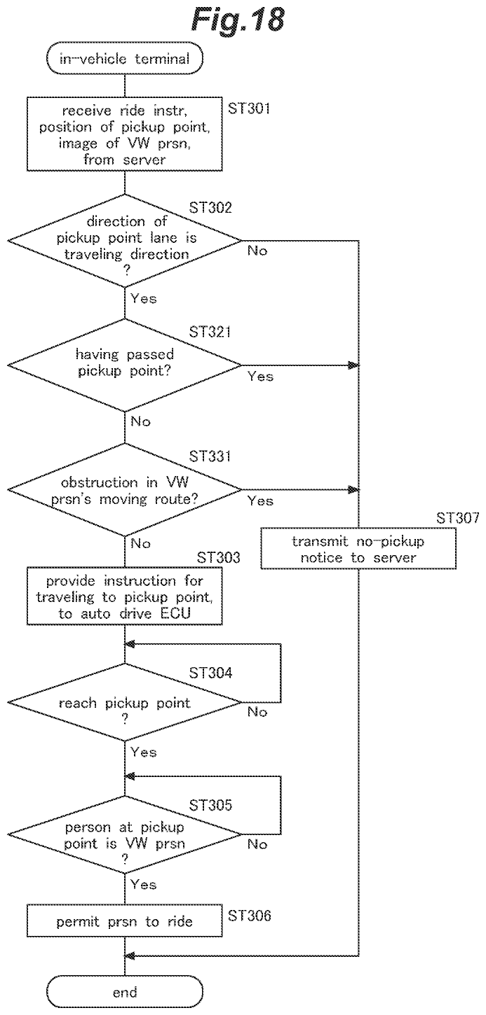

Next, a procedure of operations performed by an in-vehicle terminal 2 according to the fourth embodiment will be described. FIG. 18 is a sequence diagram showing a procedure of operations performed by an in-vehicle terminal 2. The procedures of operations performed by the roadside apparatus 4 and the server 5 are same as those of the first embodiment (FIGS. 7 and 8).

In the in-vehicle terminal 2, the wireless communication device 32 receives pickup instruction information, the position data of the pickup point, and the captured image of the vehicle waiting person from the server 5 (ST301). Next, the processor 35 determines whether or not the lane closest to the pickup point is for the same traveling direction as the lane in which vehicle is traveling based on the position data of the pickup point and the traveling lane information on the lane in which the vehicle is traveling (lane determination operation) (ST302).

Then, when determining that the lane closest to the pickup point is for the same traveling direction as the lane in which vehicle is traveling (Yes in ST302), the processor 35 determines whether or not the vehicle has already passed the pickup point based on the position data acquired by the positioning device 33, the pickup point's position data acquired from a roadside apparatus 4, and the map data stored in the memory 34 (pickup point determination operation) (ST321).

When determining that the vehicle has not passed the pickup point (No in ST321), the processor 35 determines whether or not there is a walking obstruction event in the vehicle waiting person's moving route; that is, in a route from the current position of the vehicle waiting person to the pickup point (walking obstruction determination operation) (ST331).

When determining that there is no walking obstruction event in the vehicle waiting person's moving route (No in ST331), the processor 35 provides travel instruction information including the pickup point as a destination to the autonomous driving ECU 3 (destination setting operation) (ST303). The subsequent operations are the same as those of the first embodiment (FIG. 9).

When the processor determines that the lane closest to the pickup point is not for the same traveling direction as the lane in which vehicle is traveling (No in ST302), or that the vehicle has already passed the pickup point (Yes in ST321), the wireless communication device 32 transmits a no-pickup notification to the server 5 (ST307). Upon receiving the no-pickup notification from the in-vehicle terminal 2, the server 5 re-performs the dispatching operation.

In the present embodiment, the system is configured such that an in-vehicle terminal 2 performs the walking obstruction determination operation in order to reduce overheads of communications. However, a roadside apparatus 4 may be configured to perform the walking obstruction determination operation.

### Fifth Embodiment

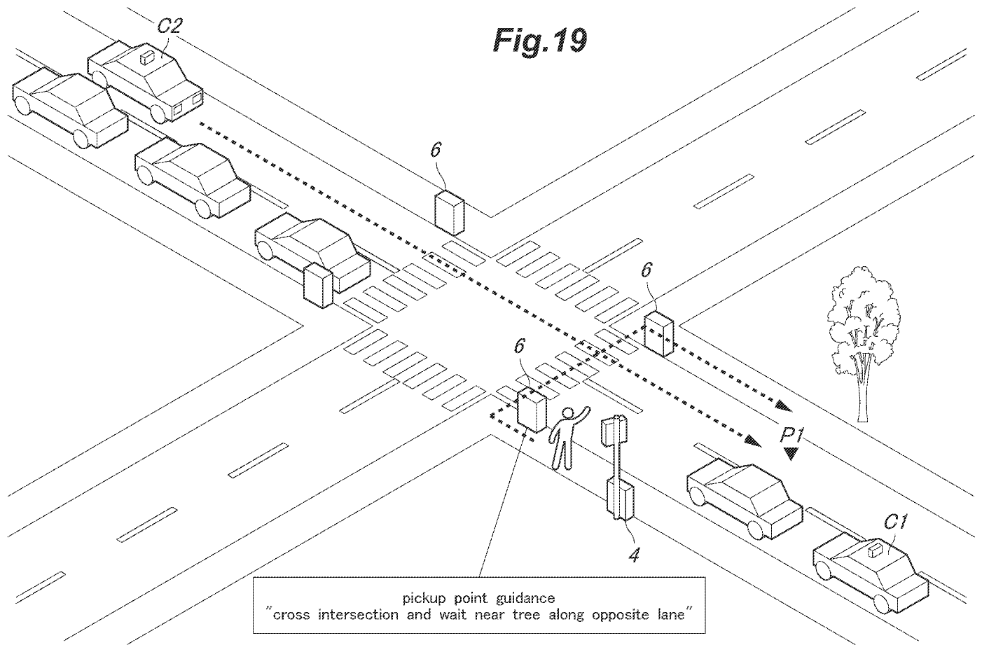

Next, a fifth embodiment of the present disclosure will be described. FIG. 19 is an explanatory diagram showing an outline of a taxi dispatching system according to a fifth embodiment.

The time for a vehicle to travel along a moving route from the current position to a pickup point can vary depending on the traffic condition in the moving route. For example, when there is an obstruction event which hinders the vehicle traveling therethrough, such as traffic jam, construction, traffic restriction (e.g., one-way traffic), or accident, in the moving route, it takes a longer time for the vehicle to reach the pickup point, and a wait time for a vehicle waiting person becomes a significantly longer.

In this view, in the present embodiment, even in the case where there is a vehicle traveling in a lane for the same traveling direction as the lane closest to the vehicle waiting person, when there is an obstruction event in the vehicle's moving route to a pickup point, the system selects a different vehicle traveling in a lane for the opposite traveling direction to the lane closest to the vehicle waiting person, and causes the selected vehicle to pick up the vehicle waiting person. As a result, a wait time for the vehicle waiting person can be prevented from being a significantly long.

In the example shown in FIG. 19, although a vehicle C1 is traveling in a lane for the same traveling direction as the lane closest to the vehicle waiting person, there is traffic congestion in the lane in which the vehicle C1 is traveling. Thus, the system excludes the vehicle C1 from the candidates to be allocated for the vehicle waiting person, and selects a vehicle C2 traveling in a lane for the opposite traveling direction to the lane closest to the vehicle waiting person, and causes the selected vehicle to pick up the vehicle waiting person.

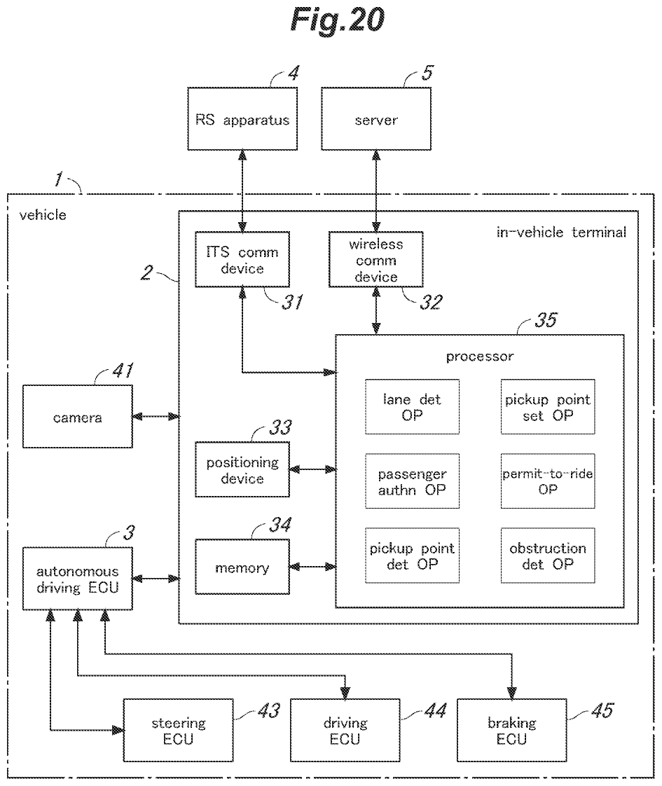

Next, a schematic configuration of an in-vehicle terminal 2 according to the fifth embodiment will be described. FIG. 20 is a block diagram showing a schematic configuration of an in-vehicle terminal 2. The configurations of the roadside apparatus 4 and the server 5 are the same as those of the first embodiment (FIGS. 4 and 5).

The in-vehicle terminal 2 is substantially the same as that of the first embodiment except that the processor 35 performs the pickup point determination operation and a traveling obstruction determination operation, in addition to the lane determination operation, the pickup point setting operation, the passenger authentication operation, and the permit-to-ride operation. The pickup point determination operation is the same as that of the third embodiment.

In the traveling obstruction determination operation, first, the processor 35 acquires a moving route for a vehicle; that is, the optimum moving route (traveling route) from the vehicle's current position to the pickup point. The processor may perform this operation based on the vehicle's position data acquired by the positioning device 33 and the pickup point's position data, and the map data stored in the memory 34. Next, the processor 35 determines whether or not there is a traveling obstruction event which hinders the vehicle traveling therethrough, in the vehicle's moving route, based on traffic information acquired from the server 5. When determining that there is a traveling obstruction event, the in-vehicle terminal transmits a no-pickup notification indicating that the vehicle is unable to pick up the vehicle waiting person, to the server 5.

In the traveling obstruction determination operation, the processor may estimate a time required for the vehicle to travel from the vehicle's current position to a pickup point to thereby determine whether or not the vehicle can arrive at the pickup point within an acceptable time period.

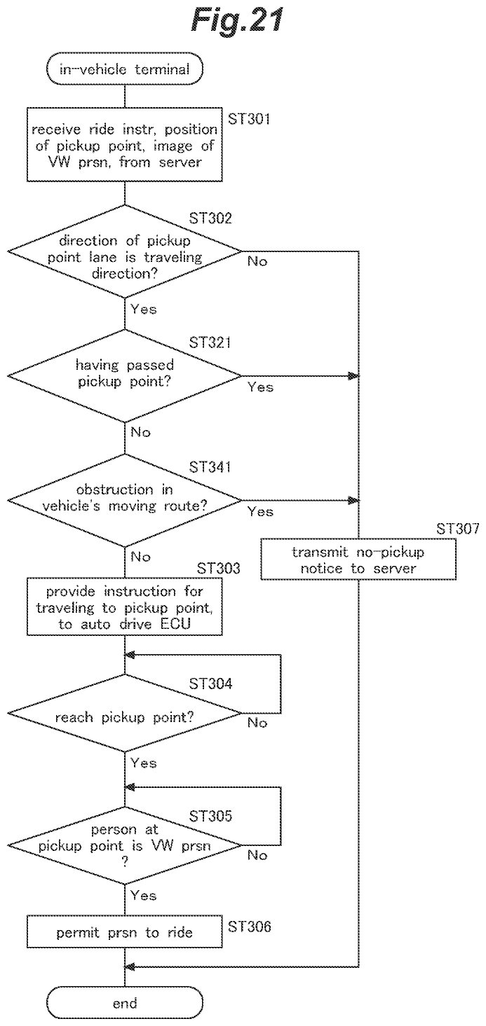

Next, a procedure of operations performed by an in-vehicle terminal 2 according to the fifth embodiment will be described. FIG. 21 is a sequence diagram showing a procedure of operations performed by an in-vehicle terminal 2. The procedures of operations performed by the roadside apparatus 4 and the server 5 are same as those of the first embodiment (FIGS. 7 and 8).

In the in-vehicle terminal 2, the wireless communication device 32 receives pickup instruction information, the position data of the pickup point, and the captured image of the vehicle waiting person from the server 5 (ST301). Next, the processor 35 determines whether or not the lane closest to the pickup point is for the same traveling direction as the lane in which vehicle is traveling based on the position data of the pickup point and the traveling lane information the lane in which the vehicle is traveling (lane determination operation) (ST302).

Then, when determining that the lane closest to the pickup point is for the same traveling direction as the lane in which vehicle is traveling (Yes in ST302), the processor 35 determines whether or not the vehicle has already passed the pickup point based on the position data acquired by the positioning device 33, the pickup point position data acquired from a roadside apparatus 4, and the map data stored in the memory 34 (pickup point determination operation) (ST321).

When determining that the vehicle has not passed the pickup point (No in ST321), the processor 35 determines whether or not there is a traveling obstruction event in the vehicle's moving route; that is, in a route from the current position of the vehicle to the pickup point (traveling obstruction determination operation) (ST341).

When determining that there is no traveling obstruction event in the vehicle's moving route (No in ST341), the processor 35 provides travel instruction information including the pickup point as a destination to the autonomous driving ECU 3 (destination setting operation) (ST303). The subsequent operations are the same as those of the first embodiment (FIG. 9).

When the processor determines that the lane closest to the pickup point is not for the same traveling direction as the lane in which vehicle is traveling (No in ST302), that the vehicle has already passed the pickup point (Yes in ST321), or that there is a walking obstruction event in the vehicle waiting person's moving route (Yes in ST341), the wireless communication device 32 transmits a no-pickup notification to the server 5 (ST307). Upon receiving the no-pickup notification from the in-vehicle terminal 2, the server 5 re-performs the dispatching operation.

In the present embodiment, the system is configured such that an in-vehicle terminal 2 performs the traveling obstruction determination operation in order to reduce overheads of communications. However, a roadside apparatus 4 may be configured to perform the traveling obstruction determination operation. In some cases, the server 5 which is connected to a device for delivering traffic information via a network, may perform the traveling obstruction determination operation.

In the present embodiment, whether or not there is a traveling obstruction event in the vehicle's moving route is determined based on traffic information. However, whether or not there is a traveling obstruction event in the vehicle's moving route may be determined based on map data. For example, when the number of right or left turns the vehicle needs to make is a predetermined value or more, the system may determine that there is a traveling obstruction event in the vehicle's moving route.

Specific embodiments of the present disclosure are described herein for illustrative purposes. However, the present disclosure is not limited to those specific embodiments, and various changes, substitutions, additions, and omissions may be made for features of the embodiments without departing from the scope of the invention. In addition, elements and features of the different embodiments may be combined with each other to yield an embodiment which is within the scope of the present disclosure.

### INDUSTRIAL APPLICABILITY

a vehicle dispatching method, an in-vehicle device, and a roadside device according to the present disclosure can implement a more convenient system that reduces a burden on a vehicle waiting person and a vehicle, and are useful as a vehicle dispatching method, an in-vehicle device, and a roadside device for dispatching a vehicle used as a taxi to a vehicle waiting person who wishes to get a ride.

### Glossary

1 vehicle
2 in-vehicle terminal (in-vehicle device)
3 autonomous driving ECU (travel control device)
4 roadside apparatus (roadside device)
5 server (server device)
6 display
7 wireless communication device
11 antenna
12 radar
13 camera
14 ITS communication device
15 network communication device
16 memory
17 processor
21 network communication device
22 memory
23 processor
31 ITS communication device
32 wireless communication device
33 positioning device
34 memory
35 processor
41 camera

1. A vehicle dispatching method,
wherein a roadside device provided on a road performs following operations:
to detect a vehicle waiting person on the road who wishes to get a vehicle ride, and acquires position data of the vehicle waiting person;
to set a pickup point based on the position data of the vehicle waiting person and map data, and acquires position data of the pickup point; and
to transmit the position data of the pickup point to a server device,
wherein the server device performs following operations:
to perform a dispatching operation for selecting a vehicle to be allocated for the vehicle waiting person, according to a positional relationship between the vehicle and the pickup point acquired based on the position data of the pickup point; and
to transmit the position data of the pickup point to an in-vehicle device mounted in the selected vehicle, and
wherein, when a controlling device, the controlling device being either the in-vehicle device or the roadside device, determines, based on the position data of the pickup point and the map data, that a lane closest to the pickup point is for the same traveling direction as a lane in which the selected vehicle is traveling, the controlling device controls the selected vehicle so that the selected vehicle moves to the pickup point.

2. The vehicle dispatching method according to claim 1, wherein, when the controlling device determines that the lane closest to the pickup point is not for the same traveling direction as the lane in which the selected vehicle is traveling, the controlling device transmits to the server device a no-pickup notification indicating that the selected vehicle is unable to pick up the vehicle waiting person, and
wherein, upon receiving the no-pickup notification, the server device re-performs the dispatching operation.

3. The vehicle dispatching method according to claim 1, wherein, when the controlling device determines that the lane closest to the pickup point is not for the same traveling direction as the lane in which the selected vehicle is traveling, and also determines, based on the position data of the pickup point and the map data, that the vehicle waiting person can cross the road and move to a second pickup point on the side of the opposite lane, the controlling device controls the selected vehicle so that the selected vehicle moves to the second pickup point.

4. The vehicle dispatching method according to claim 1, wherein, when the controlling device determines, based on the position data of the pickup point, the position data of the selected vehicle, and the map data, that the selected vehicle has already passed the pickup point, the controlling device transmits to the server device a no-pickup notification indicating that the selected vehicle is unable to pick up the vehicle waiting person.

5. The vehicle dispatching method according to claim 1, wherein the controlling device determines, based on the position data of the pickup point, the position data of the selected vehicle, and the map data, that there is a walking obstruction event which hinders the vehicle waiting person walking therethrough, in a moving route from the vehicle person's current position to the pickup point, the controlling device transmits to the server device a no-pickup notification indicating that the selected vehicle is unable to pick up the vehicle waiting person.

6. The vehicle dispatching method according to claim 1, wherein, when the controlling device determines, based on the position data of the pickup point, the position data of the selected vehicle, the map data, and traffic information, that there is a traveling obstruction event which hinders the selected vehicle traveling therethrough, in a moving route from the selected vehicle's current position to the pickup point, the controlling device transmits to the server device a no-pickup notification indicating that the selected vehicle is unable to pick up the vehicle waiting person.

7. The vehicle dispatching method according to claim 1, wherein the roadside device performs following operations:
to detect the vehicle waiting person on the road based on one or more images captured by a camera;
to extract a captured image of the vehicle waiting person from the images captured by the camera; and
to display the captured image of the vehicle waiting person on a display device that can be viewed by the vehicle waiting person.

8. The vehicle dispatching method according to claim 1, wherein the roadside device performs following operations:
to detect the vehicle waiting person on the road based on one or more images captured by a camera;
to extract a captured image of the pickup point from the images captured by the camera; and
to display the captured image of the pickup point on a display device that can be viewed by the vehicle waiting person.

9. The vehicle dispatching method according to claim 1, wherein the roadside device performs following operations:
to detect the vehicle waiting person on the road based on one or more images captured by a camera;
to extract a captured image of the vehicle waiting person from the images captured by the camera; and
to transmit the captured image of the vehicle waiting person directly or through the server device to the in-vehicle device, and
wherein the in-vehicle device confirms the vehicle waiting person based on the captured image of the vehicle waiting person.

10. An in-vehicle device comprising:
a communication device;
a memory; and
a processor,
wherein the communication device is configured to receive position data of a pickup point, where a vehicle waiting person who wishes to get a vehicle ride is to be picked up, from a server device configured to perform a dispatching operation for selecting a vehicle to be allocated for the vehicle waiting person, and
wherein, in a case where the in-vehicle device is mounted in a vehicle that is allocated for the vehicle waiting person by the server device, when the processor determines, based on the position data of the pickup point and map data stored in the memory, that a lane closest to the pickup point is for the same traveling direction as a lane in which the vehicle is traveling, the processor controls the vehicle so that the vehicle moves to the pickup point.

11. A roadside device comprising:
a communication device;
a memory; and
a processor,
wherein the processor is configured to:
detect a vehicle waiting person on a road who wishes to get a vehicle ride, and acquire position data of the vehicle waiting person; and
set a pickup point based on the position data of the vehicle waiting person and map data stored in the memory, and acquires position data of the pickup point; and
wherein the communication device is configured to transmit the position data of the pickup point to a server device, the server device being configured to perform a dispatching operation for selecting a vehicle to be allocated for the vehicle waiting person.

12. The roadside device according to claim 11, wherein, when the processor determines, based on the position data of the pickup point and the map data stored in the memory, that a lane closest to the pickup point is for the same traveling direction as a lane in which the vehicle selected by the server device is traveling, the processor controls the vehicle so that the vehicle moves to the pickup point.
